(19) United States
(12) Patent Application Publication
(10) Pub. No.: US 2008/0257169 A1
(43) Pub. Date: Oct. 23, 2008

(54) Kitchen electrical appliance

(76) Inventors: Lawrence J. Tienor, Eau Claire, WI (US); Justun C. Seymour, Menomonie, WI (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/788,811

(22) Filed: Apr. 20, 2007

(51) Int. Cl. A47J 37/06

(52) U.S. Cl. 99/377; 426/505

(57) ABSTRACT

A waffle baking appliance includes a waffle iron pivotally mounted to a stationary base, the waffle iron being pivotable between a first disposition and a second inverted disposition, baking heat being appliable to the waffle iron in both the first and the second dispositions. A method for baking a waffle is further included.

### TECHNICAL FIELD

The present invention relates to a kitchen electrical appliance. More particularly, the present invention is an appliance useful in baking a waffle.

### BACKGROUND OF THE INVENTION

It has been known that flipping (inverting) a waffle-iron during the cooking process enhances the final product. Flipping the waffle-iron results in better uniformity in the spreading of batter between the irons, resulting in a more uniformly cooked product. Also, flipping causes air bubbles, which tend to rise in the waffle batter, to assume a more central location in the waffle, further contributing to the uniformity of the cooked product.

Kitchen electric appliances are known that show a flipping waffle-iron to exploit those advantages, such as the appliance described in U.S. Pat. No. 7,021,199. However, such devices are relatively quite large and therefore require a substantial amount of storage space and, due to the large amount of material incorporated in constructing the device, are costly to manufacture. Another type of waffle-iron, a product of Hamilton Beach known as a Belgian Waffle Baker, allows for the inversion of the waffle-iron during baking, but does not include a display component allowing the user to monitor baking time that is readily viewable by the user during the entire baking process. Stationary (non-flipping) waffle-irons have the advantage of presenting controls and a baking display to the user continuously throughout the baking process.

There is then a need in the industry for an inexpensive flip waffle maker that is easy to store and allows for stationary controls and display that is accessible by the user in all modes of operation.

### SUMMARY OF THE INVENTION

The present invention substantially meets the aforementioned needs of the industry and includes an innovative flip mechanism for a waffle maker. It combines the advantages of a stationary waffle-iron with a flip waffle-iron. Like a stationary waffle-iron, the present invention incorporates a display panel that is mounted in a stationery base and is therefore accessible and viewable at every stage of use. This allows the user to maintain control during the waffle baking process, and provides continuous feedback during that process. The superior baking of a flip waffle-iron is also obtained by providing a stationary base and a pivotally mounted waffle iron, resulting in an evenly cooked waffle. By combining the advantages of a stationary and flip waffle-iron, the result is a waffle-iron that is easy to use and control, that produces an excellent food product, and that uses a minimum of counter space and stores conveniently in a typical kitchen cabinet.

The present invention is a waffle baking appliance, including a waffle iron pivotally mounted to a stationary base, the waffle iron being pivotable between a first disposition and a second inverted disposition, baking heat being appliable to the waffle iron in both the first and the second dispositions and a continuously viewable display being mounted on the base. The present invention is further a method for baking a waffle.

### BRIEF DESCRIPTION OF THE DRAWINGS

The invention may be more completely understood in consideration of the following detailed description of various embodiments of the invention in connection with the accompanying drawing, in which:

FIG. 1 is a perspective view of the kitchen appliance in the horizontal cooking position;

FIG. 2 is a fragmentary perspective view of the kitchen appliance in the horizontal cooking position showing the pivot bearing;

FIG. 3 is a fragmentary perspective view of the base of the kitchen appliance with the control panel cover removed and showing the pivot axle;

FIG. 4 is a fragmentary perspective view of the kitchen appliance in the horizontal cooking position with cover removed to show internal components of a hot plate;

FIG. 5 is a fragmentary perspective view of the kitchen appliance in the horizontal cooking position showing external components of the hot plate;

FIG. 6 is a perspective view of the kitchen appliance in the horizontal, open position; and

FIG. 7 is a fragmentary perspective view of the kitchen appliance with a cover removed to show internal components of a hot plate and displaying components of the hinge mechanism.

### DETAILED DESCRIPTION

A kitchen electrical appliance or waffle maker is depicted generally at 10 in the Figures. Generally, the waffle maker 10 is used to cook liquid batter in order to convert the liquid batter to an aerated solid product, preferably with a browned outer surface, such as a waffle.

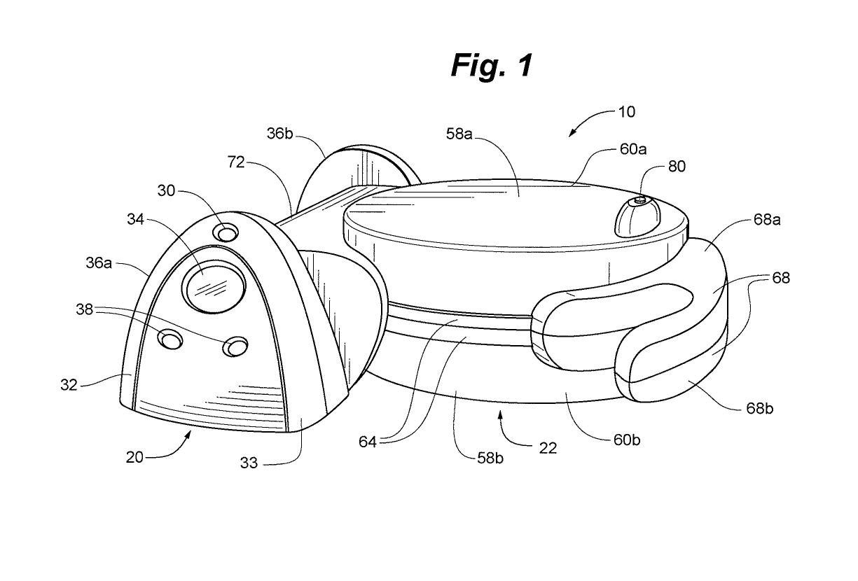

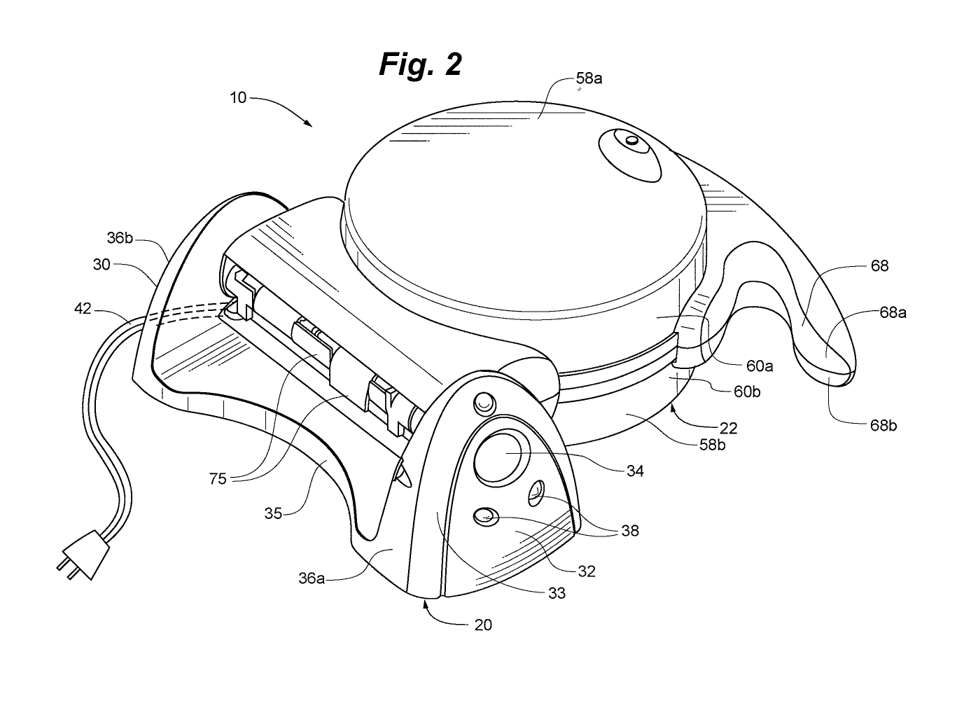

As shown in FIGS. 1 and 2, the waffle maker 10 is comprised primarily of two components, a base 20 and a waffle-iron 22. The base 20 is comprised of a housing 30, preferably made of a durable material such as thermal plastic. The housing 30 has a center section 35 flanked by two uprights 36a, 36b. A control panel 32, mounted to upright 36a, provides control and feedback mechanisms for the user. As noted in the Figures, the control panel 32, by being mounted on the stationary base 20 is continually viewable by an operator during the cooking process without regard to the disposition of the various components of the waffle-iron 22. The control panel 32 includes a display 34 and timer control 38. The display 34 can include a clock, timer, etc. Preferably, the display 34 includes a countdown timer showing the amount of time remaining for the waffle to be fully cooked. The display 34 can activate an auditory indication to the user upon the expiration of the set time. The timer control 38 may include two control buttons, one of which adjusts the minutes displayed on the display 34, and the other controls the seconds on the display 34.

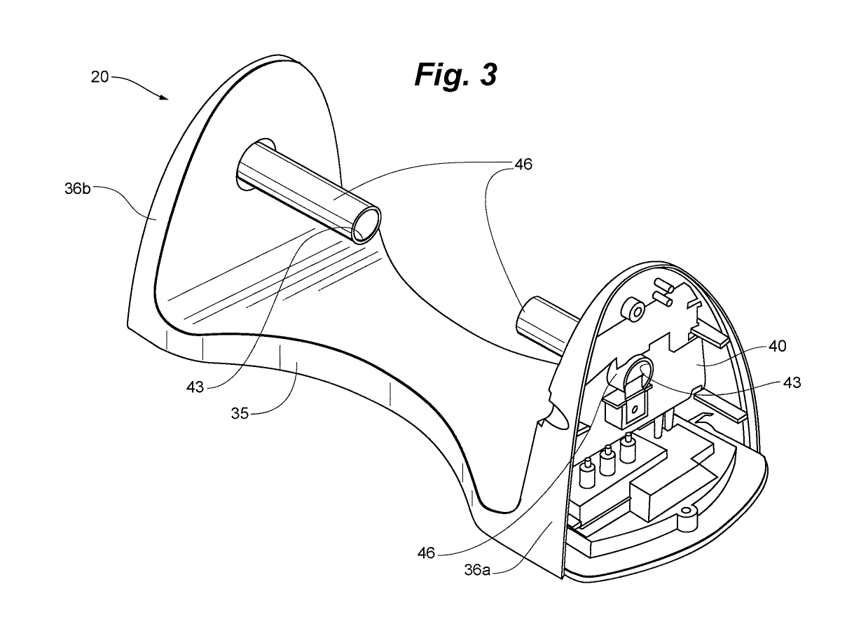

As shown in FIG. 2, the base 20 also includes an electrical cord 42, and as shown in FIG. 3, the base 20 includes an interrupted pivot axle 46 to which the waffle-iron 22 is pivotally coupled. Electrical power is transmitted from the cord 42 to components disposed in the electrical panel 40, and thence distributed to the waffle-iron 22 via the interior passage 43 defined in the axle 46. The control panel 32 is also electrically coupled to power in the electrical panel 40 when the control panel cover 33 (see FIG. 1) is mated to the base 20.

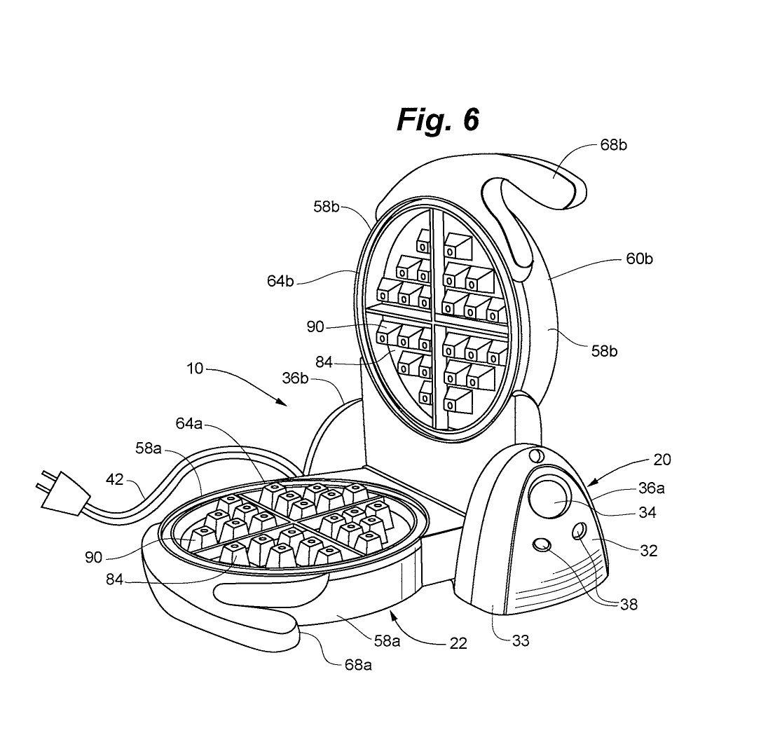

The waffle-iron 22 is the other major component of the waffle maker 10. The waffle-iron 22 includes two substantially identical waffle-iron halves 58a, 58b. The waffle-iron halves 58a, 58b are selectively matable together in the cooking disposition of FIG. 1 and are separable, as depicted in FIG. 6 for removal of a cooked waffle or for the introduction of batter thereto. Accordingly, the waffle-iron halves 58a, 58b are independently pivotally coupled to the axle 46. The waffle-iron halves 58a, 58b may be rotated relative to the axle 46 in concert or individually, as desired.

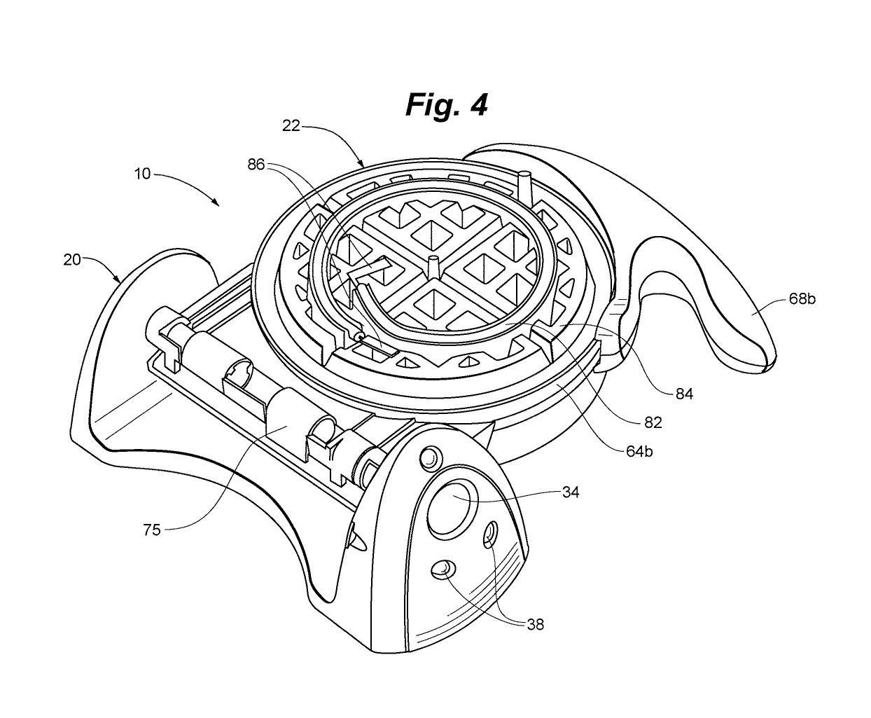

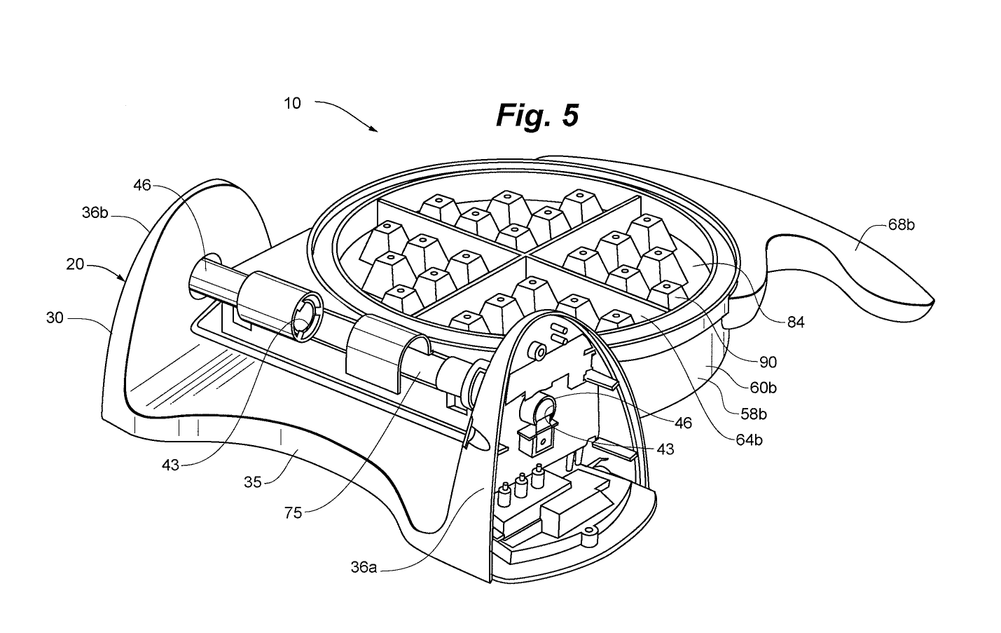

The waffle-iron halves 58a, 58b of the waffle-iron 22 includes a pair of respective, substantially mirror image outer shells 60a, 60b. Each of the outer shells 60a, 60b is composed of a heat resistant material, such as stainless steel and functions as a cover for the respective hot plates 64a, 64b. Removal of an outer shell 60a, 60b exposes the underside of the heating elements, as depicted in FIG. 4, described in greater detail below. A respective hot plate 64a, 64b, as depicted in FIGS. 5 and 6, is mounted on each outer shell 60a, 60b. A flip handle half 68a, 68b is mounted on a portion of a respective outer shell 60a, 60b. When the waffle-iron 22 is in the closed (cooking) disposition of FIGS. 1 and 2, the flip handle halves 68a, 68b are mated to one another to form a single flip handle 68. A support 80, preferably made of a resilient material such as rubber, is mounted on an outer surface of each of the outer shells 60a, 60b. The support 80 rests on the countertop to support the respective waffle-iron half 58a, 58b of the waffle-iron 22 when a respective waffle-iron half 58a, 58b is flipped to a disposition overlying the countertop.

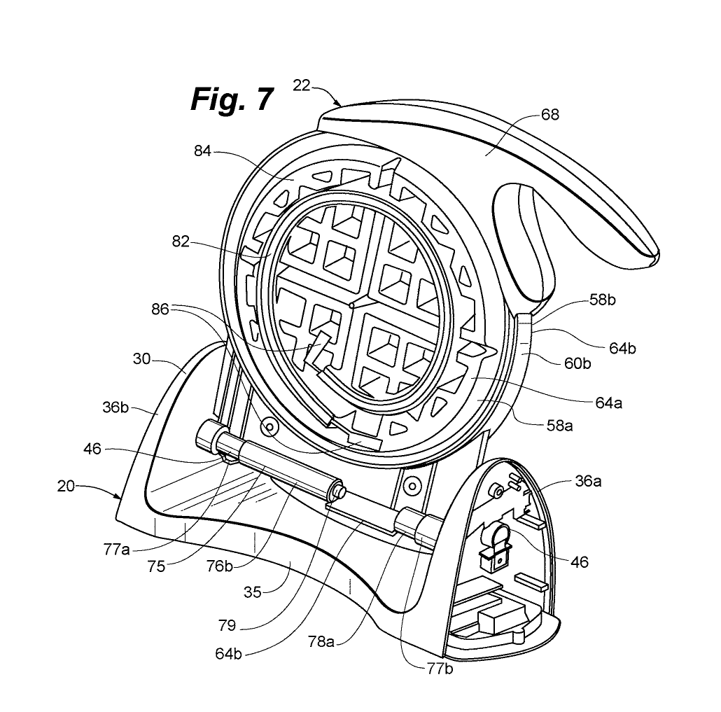

As shown in FIGS. 4 and 7, each of the hot plates 64a, 64b is comprised of a resistive heating element 82, an irregular thermal conductor 84, electrical terminals 86, and, as shown in FIG. 5, a batter surface 90. The resistive heating element 82 may be made of any of a variety of resistive, non-conducting elements, such as a Calrod™ brand element (Calrod is a registered trademark of the General Electric Company.) The resistive heating element 82 is comprised of an electrically conductive, thermally conductive element, such as copper, encased in a non-electrically conductive, thermally conductive material such as MgO. Two electrical terminals 86 connect either end of the resistive heating element 82 to the electrical cord 42 in order to transfer electrical current through the resistive heating element 82.

The irregular thermal conductor 84 includes the batter surface 90 and may be made of any number of materials such as iron or iron alloys that effectively conduct heat and maintain a particular shape throughout the heating/cooling process. The batter surface 90 of the irregular thermal conductor 84 may further be coated with a non-stick material such as polytetrafluoroethylene (PTFE), thus improving the ability of the finished waffle food product to be removed from the contact surface of the irregular thermal conductor 84. As depicted in FIG. 5, one of many possible batter surfaces 90 is depicted which allow for an irregular surface of a waffle. Such an irregular batter surface 90 can provide structural strength to the waffle and additionally provides voids in the baked waffle to hold syrup, butter, or other condiments.

FIG. 7 shows the interworking of the components of the hinge assembly 75 to allow the respective hot plates 64a, 64b to independently rotate relative to the base 20. The two opposed halves of the pivot axle 46 are fit into respective uprights 36a, 36b of the housing 30. Hot plate 64a includes pivot bearings 77a, and 78a. Hot plate 64b includes pivot bearings 76b. The pivot bearings 76b, 77a, and 78a provide independent rotational engagement of the respective hot plates 64a, 64b with pivot axle 46. The pivot bearings 77a, and 78a of the hot plate 64a flank the pivot bearing 76b of the hot plate 64b. Spring 79 provides a low friction conduit for electric wiring that connects the element 82 to the power cord 42 and the control panel 32.

In FIG. 6, the waffle-maker 10 is shown in the open position. The horizontal hot plate 64a is positioned to receive waffle batter or to remove a baked waffle. Resistive heating element 84 is energized, simultaneously raising the temperature of the hot plates 64a, 64b to a desired operating temperature, approximately 400° F. A user-determined amount of batter is then poured onto plate 64a. Flip handle half 68a (comprising half of the flip handle halves 68) is then grasped by the user and utilized to lower hot plate 64b into contact with hot plate 64a.

During to baking process, the user then grasps flip handle 68 and rotates the waffle-iron 20 through 180 degrees, ending with hot plate 64a residing above, and still in contact with, hot plate 64b, which is immediately above the underlying counter top. Generally, the waffle-iron 20, including both waffle-iron halves 58a, 58b of the waffle-iron 22, is flipped (inverted) by being rotated about axle 46 from a first side to the base 22 to the opposed second side of the base 22, the base 22 remaining stationary during the transition. During the entire baking process, the display 32 is continuously viewable by the user to monitor the baking progress. After the baking cycle is complete, approximately 3½ minutes, the user then grasps handle 68a and raises it to a resting position, generally greater than 90 degrees from horizontal. The user may then remove the baked waffle and start the process over.

The above disclosure is not intended as limiting. Those skilled in the art will readily observe that numerous modifications and alterations of the device may be made while retaining the teachings of the invention. Accordingly, the above disclosure should be construed as limited only by the restrictions of the appended claims.

1. A waffle baking appliance, comprising:
a waffle iron pivotally mounted to a stationary base, the waffle iron being pivotable between a first disposition and a second inverted disposition, baking heat being appliable to the waffle iron in both the first and the second dispositions; and
a continuously viewable display being mounted on the base.

2. The appliance of claim 1 wherein said display panel includes a countdown timer.

3. The appliance of claim 1 wherein said display includes temperature readout.

4. The appliance of claim 1 wherein a support is provided on at least one outer surface of said waffle iron.

5. The appliance of claim 1 wherein said waffle iron comprises two patterned conductive plates.

6. The appliance of claim 5 wherein each of said conductive metal plates has a resistive heater operatively connected to the non-working surface of said each metal plate.

7. The appliance of claim 6 wherein said resistive heater comprises an electrically conductive, thermally conductive element is enclosed in a non-electrically conductive, thermally conductive matrix.

8. The appliance of claim 7 wherein a handle is operatively connected to each of said plates.

9. A waffle baking appliance, comprising:
a flippable waffle iron, flippable between a first disposition and a second disposition and presenting a display panel on a base, monitorable by an operator without regard to the disposition of the waffle iron on the base, where said base is rotatably attached to said waffle iron.

10. The appliance of claim 9 wherein said display panel includes a countdown timer.

11. The appliance of claim 9 wherein said display includes temperature readout.

12. The appliance of claim 9 wherein a support is provided on at least one outer surface of said waffle iron.

13. The appliance of claim 9 wherein said waffle iron comprises two patterned conductive plates.

14. The appliance of claim 13 wherein each of said conductive metal plates has a resistive heater operatively connected to the non-working surface of said each metal plate.

15. The appliance of claim 14 wherein said resistive heater comprises an electrically conductive, thermally conductive element is enclosed in a non-electrically conductive, thermally conductive matrix.

16. The appliance of claim 15 wherein a handle is operatively connected to each of said plates.

17. A method for baking a waffle, comprising:
disposing a batter between a first hot plate and a second opposed hot plate in a first hot plate disposition;
applying heat to the first and second hot plates;
flipping the first and second hot plates to a second inverted hot plate disposition; and
presenting a continuously viewable display.

18. The method of claim 17, wherein said viewable display consists of a liquid crystal display.

19. The method of claim 17, wherein said viewable display imparts cooking status information including time remaining in cooking cycle.

20. The method of claim 17, comprising the additional step of lifting the upper hotplate to an approximately 90 degree angle from the lower hotplate.
